(19) United States
(12) Patent Application Publication
(10) Pub. No.: US 2013/0043979 A1
(43) Pub. Date: Feb. 21, 2013

(54) DISPLAY METHOD FOR ELECTRONIC PAPER LABEL APPARATUS

(71) Applicants: Wei-Chun Huang, Taipei City (TW); Tsung-Hsing Hsieh, Taipei City (TW)

(72) Inventors: Wei-Chun Huang, Taipei City (TW); Tsung-Hsing Hsieh, Taipei City (TW)

(73) Assignee: PRODIGIO LIMITED

(21) Appl. No.: 13/211,444

(22) Filed: Aug. 17, 2011

(51) Int. Cl. H04Q 5/22

(52) U.S. Cl. 340/10.1

(57) ABSTRACT

A display method for electronic paper label apparatus first detects a serial number of an electronic paper label by a handheld device. Then a wireless display signal corresponding to the serial number is sent from the handheld device to the electronic paper label. Finally, the display content of an electronic paper of the electronic paper label is changed by the wireless display signal.

### BACKGROUND OF THE INVENTION

1. Field of the Invention

The present invention relates to a display method, and especially relates to a display method for electronic paper label apparatus.

2. Description of Prior Art

The electronic paper is a great invention. Unlike the conventional display devices, the electronic paper is very light and thin, and is able to bend (namely, flexible). Changing the contents of the electronic paper will need power, but when there is no power for the electronic paper, the electronic paper still can display the original contents for several months. The electronic papers are used widely, for example the electronic shelf label system. The electronic shelf label system can save a lot of papers and labor cost.

ZigBee or other wireless technologies could change the display contents of the electronic shelf label (for example, the description of the goods, or price of the goods). But maintaining the equipment and software of the wireless technologies for changing the display contents of the electronic shelf label will require a lot of man power and cost. Moreover, the wireless technologies mentioned above could not accurately locate the electronic shelf label which is required to change the display contents (especially the upper shelf and the lower shelf at the same location). Therefore, it will induce the mistake changing the display contents of the electronic shelf label incorrectly.

### SUMMARY OF THE INVENTION

In order to solve the above-mentioned problems, an object of the present invention is to provide a display method for electronic paper label apparatus, to reduce the cost and change the display contents of the electronic paper label accurately.

In order to achieve the object of the present invention mentioned above, the display method for electronic paper label apparatus of the present invention includes following steps. A wireless serial number signal of a serial number unit of an electronic paper label apparatus is received by a serial number receiving-identifying unit of a handheld device. A serial number information is sent from the serial number receiving-identifying unit to a handheld-device-side microcontroller of the handheld device after the wireless serial number signal is received by the serial number receiving-identifying unit. A display information corresponding to the serial number information is sent from the handheld-device-side microcontroller to a short-range wireless transmitter of the handheld device after the serial number information is received by the handheld-device-side microcontroller. A wireless display signal is sent from the short-range wireless transmitter after the display information is received by the short-range wireless transmitter. The display information is recovered by a short-range wireless receiver of the electronic paper label apparatus and is sent from the short-range wireless receiver to a label-side microcontroller of the electronic paper label apparatus after the wireless display signal is received by the short-range wireless receiver. The display information is sent from the label-side microcontroller to an electronic paper of the electronic paper label apparatus after the display information is received by the label-side microcontroller. The content of the display information is displayed by the electronic paper after the display information is received by the electronic paper.

The efficiency of the present invention is to reduce the cost and change the display content of the electronic paper label accurately.

### BRIEF DESCRIPTION OF DRAWING

FIG. 1 shows a block diagram applied to the display method for electronic paper label apparatus of the present invention.

FIG. 2 shows a flow chart of the display method for electronic paper label apparatus of the present invention.

### DETAILED DESCRIPTION OF THE INVENTION

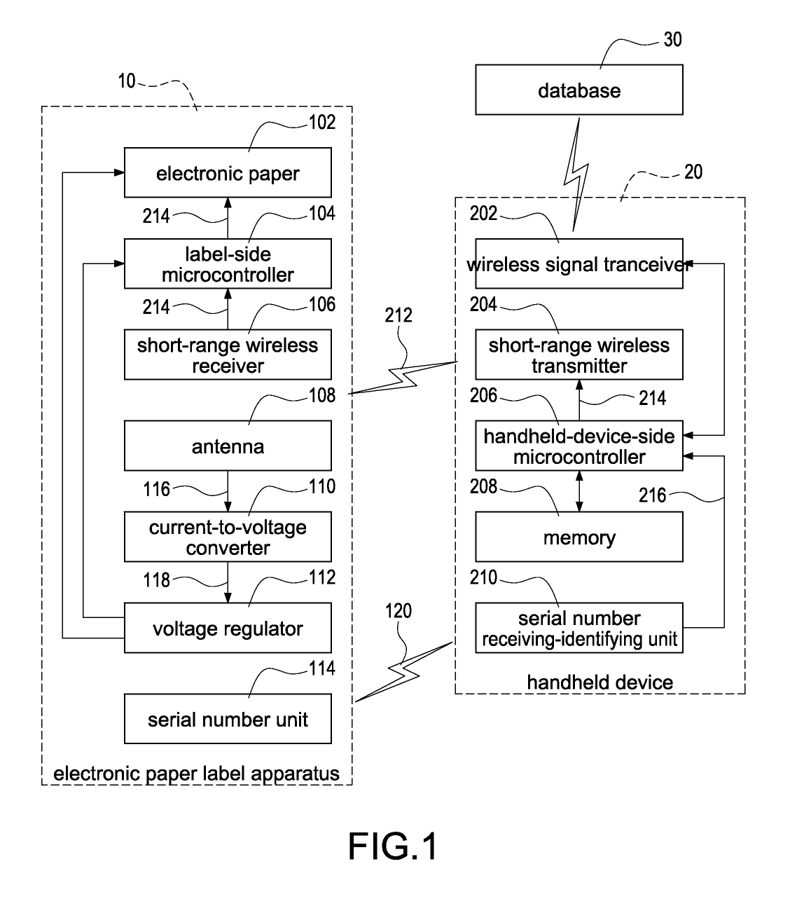

FIG. 1 shows a block diagram applied to the display method for electronic paper label apparatus of the present invention.

An electronic paper label apparatus 10 includes an electronic paper 102, a label-side microcontroller 104, a short-range wireless receiver 106, an antenna 108, a current-to-voltage converter 110, a voltage regulator 112, and a serial number unit 114.

A handheld device 20 includes a wireless signal transceiver 202, a short-range wireless transmitter 204, a handheld-device-side microcontroller 206, a memory 208, and a serial number receiving-identifying unit 210.

The voltage regulator 112 is electrically connected to the current-to-voltage converter 110, the electronic paper 102, and the label-side microcontroller 104. The antenna 108 is electrically connected to the current-to-voltage converter 110. The label-side microcontroller 104 is electrically connected to the electronic paper 102, and the short-range wireless receiver 106.

The handheld-device-side microcontroller 206 is electrically connected to the wireless signal transceiver 202, the short-range wireless transmitter 204, the memory 208, and the serial number receiving-identifying unit 210.

The handheld device 20 could be a personal digital assistant or a smart phone.

The serial number unit 114 could be a barcode (a physical barcode sticker, or a barcode shown on the electronic paper 102), so that the serial number receiving-identifying unit 210 is a barcode receiving-identifying circuit. Or the serial number unit 114 could be a radio frequency identification tag, so that the serial number receiving-identifying unit 210 is a radio frequency identification reader.

The short-range wireless transmitter 204 could be a radio frequency identification reader, so that the short-range wireless receiver 106 is a radio frequency identification tag. Or the short-range wireless transmitter 204 could be a near field communication transmitter, so that the short-range wireless receiver 106 is a near field communication receiver.

The radio frequency identification mentioned above could be high frequency radio frequency identification, for example ISO15693, ISO14443A, ISO14443B, or could be low frequency radio frequency identification, for example ISO11784, ISO11785. The near field communication mentioned above could be ISO18092.

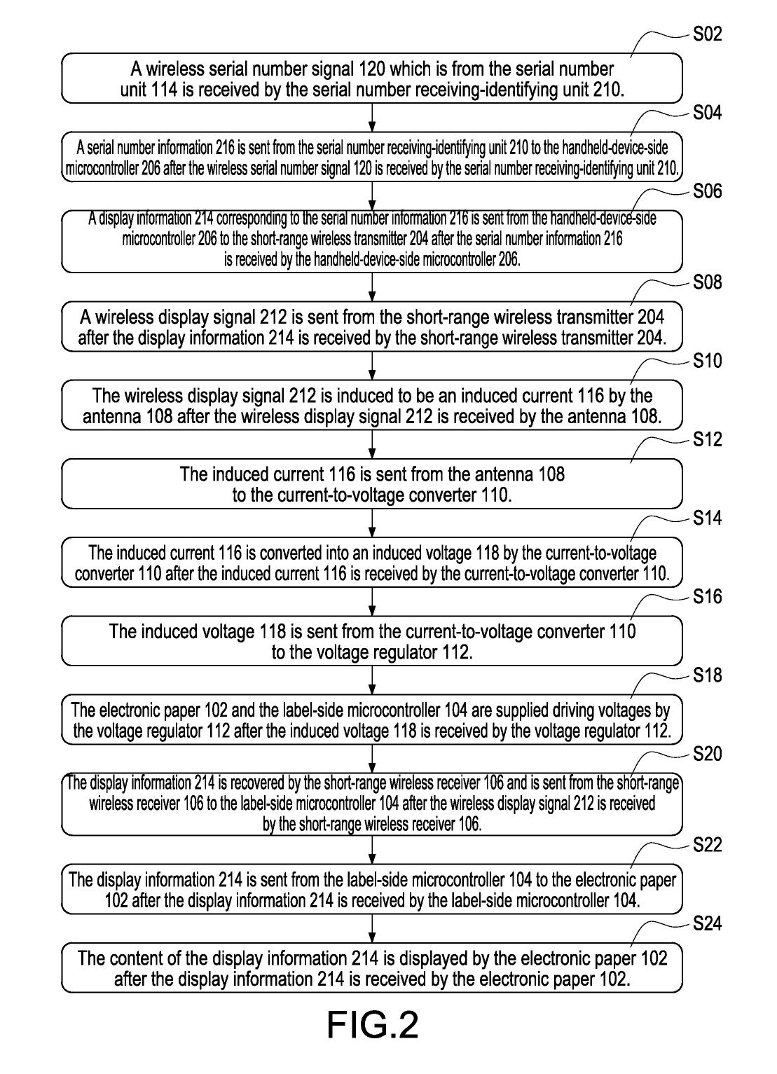

FIG. 2 shows a flow chart of the display method for electronic paper label apparatus of the present invention. Please refer to FIG. 1 as well. The display method for electronic paper label apparatus of the present invention includes following steps:

S02: A wireless serial number signal 120 which is from the serial number unit 114 is received by the serial number receiving-identifying unit 210.

If the serial number unit 114 is a barcode, the serial number receiving-identifying unit 210 is a barcode receiving-identifying circuit. The barcode receiving-identifying circuit needs to align the barcode in a short distance, then detects the serial number of the barcode with infrared ray or laser or other barcode technologies.

If the serial number unit 114 is a radio frequency identification tag, the serial number receiving-identifying unit 210 is a radio frequency identification reader. The radio frequency identification reader needs to approach the radio frequency identification tag, then detects the serial number of the radio frequency identification tag with radio frequency identification technology.

S04: A serial number information 216 is sent from the serial number receiving-identifying unit 210 to the handheld-device-side microcontroller 206 after the wireless serial number signal 120 is received by the serial number receiving-identifying unit 210.

S06: A display information 214 corresponding to the serial number information 216 is sent from the handheld-device-side microcontroller 206 to the short-range wireless transmitter 204 after the serial number information 216 is received by the handheld-device-side microcontroller 206.

The display information 214 corresponding to the serial number information 216 is derived by the handheld-device-side microcontroller 206, which compares the information (namely, finds the corresponding information) stored in the memory 208 with respect to the serial number information 216. Or the display information 214 corresponding to the serial number information 216 is derived by the handheld-device-side microcontroller 206, which receives the information stored in an external database 30 through the wireless signal transceiver 202 and then compares the information (namely, finds the corresponding information) stored in the database 30 with respect to the serial number information 216.

S08: A wireless display signal 212 is sent from the short-range wireless transmitter 204 after the display information 214 is received by the short-range wireless transmitter 204.

S10: The wireless display signal 212 is induced to be an induced current 116 by the antenna 108 after the wireless display signal 212 is received by the antenna 108.

S12: The induced current 116 is sent from the antenna 108 to the current-to-voltage converter 110.

S14: The induced current 116 is converted into an induced voltage 118 by the current-to-voltage converter 110 after the induced current 116 is received by the current-to-voltage converter 110.

S16: The induced voltage 118 is sent from the current-to-voltage converter 110 to the voltage regulator 112.

S18: The electronic paper 102 and the label-side microcontroller 104 are supplied driving voltages by the voltage regulator 112 after the induced voltage 118 is received by the voltage regulator 112.

S20: The display information 214 is recovered by the short-range wireless receiver 106 and is sent from the short-range wireless receiver 106 to the label-side microcontroller 104 after the wireless display signal 212 is received by the short-range wireless receiver 106.

S22: The display information 214 is sent from the label-side microcontroller 104 to the electronic paper 102 after the display information 214 is received by the label-side microcontroller 104.

S24: The content of the display information 214 is displayed by the electronic paper 102 after the display information 214 is received by the electronic paper 102.

The electronic paper label apparatus 10 could include a battery (not shown in the FIG. 1) to supply driving voltages to the electronic paper 102 and the label-side microcontroller 104. Therefore, the antenna 108, the current-to-voltage converter 110, and the voltage regulator 112, which are used for converting the wireless display signal 212 into driving voltages, are not necessary for the electronic paper label apparatus 10. From the step S10 to the step S18, which convert the wireless display signal 212 into driving voltages, are not necessary, either.

As mentioned in the prior art, maintaining the equipment and software of the wireless technologies for changing the display contents of the electronic shelf label will require a lot of man power and cost, but still can't accurately locate the electronic shelf label which is required to change the display contents. Therefore, it will induce the mistake changing the display contents of the electronic shelf label incorrectly.

When a user uses the display method for electronic paper label apparatus of the present invention, the user only needs to walk to and stand before the shelf (for example, a worker who is carrying goods carries goods to the shelf), then takes the handheld device 20 align (or approach) to the serial number unit 114 of the electronic paper label apparatus 10. The handheld device 20 could compare the serial number unit 114 with the information stored in the memory 208 or in the database 30 to derive the display information 214. Finally the display information 214 is sent from the handheld device 20 to the electronic paper label apparatus 10 to change the display contents on the electronic paper 102 of the electronic paper label apparatus 10. Therefore, the efficiency of the present invention is to reduce the cost and change the display content of the electronic paper label accurately.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A display method for electronic paper label apparatus including following steps:
a. a serial number receiving-identifying unit of a handheld device receiving a wireless serial number signal of a serial number unit of an electronic paper label apparatus;
b. the serial number receiving-identifying unit sending a serial number information to a handheld-device-side microcontroller of the handheld device after the wireless serial number signal is received by the serial number receiving-identifying unit;
c. the handheld-device-side microcontroller sending a display information corresponding to the serial number information to a short-range wireless transmitter of the handheld device after the serial number information is received by the handheld-device-side microcontroller;
d. the short-range wireless transmitter sending a wireless display signal after the display information is received by the short-range wireless transmitter;
e. a short-range wireless receiver of the electronic paper label apparatus recovering the display information and sending the display information to a label-side microcontroller of the electronic paper label apparatus after the wireless display signal is received by the short-range wireless receiver;
f. the label-side microcontroller sending the display information to an electronic paper of the electronic paper label apparatus after the display information is received by the label-side microcontroller; and
g. the electronic paper displaying the content of the display information after the display information is received by the electronic paper.

2. The display method for electronic paper label apparatus in claim 1, wherein in the step c, the display information corresponding to the serial number information is derived by using the handheld-device-side microcontroller to compare the information stored in a memory of the handheld device with reference to the serial number information.

3. The display method for electronic paper label apparatus in claim 1, wherein in the step c, the display information corresponding to the serial number information is derived by using the handheld-device-side microcontroller to receive the information stored in an external database through a wireless signal transceiver of the handheld device and to compare the information stored in the database with reference to the serial number information.

4. The display method for electronic paper label apparatus in claim 1, wherein the serial number unit is a barcode; the serial number receiving-identifying unit is a barcode receiving-identifying circuit.

5. The display method for electronic paper label apparatus in claim 1, wherein the serial number unit is a radio frequency identification tag; the serial number receiving-identifying unit is a radio frequency identification reader.

6. The display method for electronic paper label apparatus in claim 1, wherein the short-range wireless transmitter is a radio frequency identification reader; the short-range wireless receiver is a radio frequency identification tag.

7. The display method for electronic paper label apparatus in claim 1, wherein the short-range wireless transmitter is a near field communication transmitter; the short-range wireless receiver is a near field communication receiver.

8. The display method for electronic paper label apparatus in claim 1, further including following steps after the step d:
d1. the antenna inducing the wireless display signal into an induced current after the wireless display signal is received by the antenna; and
d2. the antenna sending the induced current to a current-to-voltage converter of the electronic paper label apparatus.

9. The display method for electronic paper label apparatus in claim 8, further including following steps after the step d2:
d3. the current-to-voltage converter converting the induced current into an induced voltage after the induced current is received by the current-to-voltage converter; and
d4. the current-to-voltage converter sending the induced voltage to a voltage regulator of the electronic paper label apparatus.

10. The display method for electronic paper label apparatus in claim 9, further including following step after the step d4:
d5. the voltage regulator supplying driving voltages to the electronic paper and the label-side microcontroller after the induced voltage is received by the voltage regulator.
